(19) United States
(12) Patent Application Publication
(10) Pub. No.: US 2017/0105902 A1
(43) Pub. Date: Apr. 20, 2017

(54) Mason Baby Bottle Lid

(71) Applicant: Kinetika, Inc., Sedona, AZ (US)

(72) Inventors: Laura Palm Belmar, Sedona, AZ (US); Sebastian Ignacio Belmar Ponce, Sedona, AZ (US)

(21) Appl. No.: 15/295,397

(22) Filed: Oct. 17, 2016

Related U.S. Application Data
(60) Provisional application No. 62/242,462, filed on Oct. 16, 2015.

(51) Int. Cl. A61J 11/04; A61J 11/02; B65D 1/10; A61J 11/00

(52) U.S. Cl. CPC A61J 11/04; A61J 11/0035; A61J 11/02; B65D 1/10

(57) ABSTRACT

A mason jar baby bottle lid includes a metal threaded mason jar collar and a bottle nipple formed of a flexible and non-toxic material. The bottle nipple has a domed body portion having a nipple projecting from an upper end of the domed body, a flange including an upward-projecting lip formed on the lower end of the domed body, and an annular indentation formed between the flange and the domed body of the bottle nipple and including an overhang surface. A height of the upwardly protruding lip of the flange is such that when the bottle nipple is engaged with the mason jar collar, the overhang surface is adjacent the substantially flat upper surface of the collar.

### CROSS-REFERENCE TO RELATED APPLICATION

This application claims priority to U.S. Provisional Patent Application Ser. No. 62/242,462 for a “Glass Jar Baby Bottle” by Laura Palm Belmar, which was filed on Oct. 16, 2015, the contents of which are incorporated herein by reference in its entirety.

### FIELD

This disclosure relates to the field of feeding and food storage. More particularly, this disclosure relates to a baby bottle lid compatible with a standard mason or canning jar.

### BACKGROUND

Families are often forced to buy products that serve a single purpose or are single-use. This is the case when it comes to baby feeding. Parents, particularly those who breastfeed, have a need not just for a baby bottle, but also for a vessel to store extra breast milk that has been pumped by the mother for future use. Currently, the most common solution to milk storage is to purchase bags designed specifically for breast milk storage. The bags are single-use, so this solution can be expensive and wasteful. The bags must also be stored upright and cannot be stacked, so they take up a considerable amount of space in the refrigerator or freezer. Additionally, they often leak because if any milk gets into the seal, it will expand and break the seal as it freezes.

Families may also purchase plastic breast milk storage vials. The vials do not leak and are stackable, however their narrow shape does not make them ergonomically compatible with infant self-feeding. Transferring the milk from the storage vial to a baby bottle can cause spillage and creates extra dishes to wash. Alternatively, buying extra baby bottles is another option for milk storage. However, baby bottles have shoulders that make them impossible to stack because the base of each bottle is much wider than the top.

In addition to being impossible to stack, baby bottles designed with a shoulder are also much more difficult to clean. The shoulder narrows the opening of the bottle making it impossible to insert a regular kitchen sponge or kitchen brush into the bottle for cleaning. The shoulder itself is a particularly difficult area to reach for sterilization, even with the use of a special bottle brush.

Some prior art includes baby bottles that can be converted to drinking vessels for toddlers. However, the vessels do not serve a purpose after the child has grown. Either the form, function or design of the vessel becomes inappropriate for an older child or adult, or the vessel must be thrown away or recycled.

Because this product is compatible with standard canning jars, it is worth addressing their most common design failure as well. The typical canning jar comes with a two-piece top: a metal collar and a metal lid with a rubber coating. These materials work well to create a seal when properly canned. However, they are designed to be single use. The metal rusts and the rubber lid will not form a seal upon the second use.

Silicone sleeves made to protect glass jars are notorious for being difficult to remove for cleaning. Many products suggest that removing the sleeve is never necessary, however particulate matter and bacteria build up between the sleeve and the bottle over time. If removed, it is impossible to put the sleeve back on the bottle after cleaning, or it is so time consuming that the user gives up. However, if a silicone sleeve is too loose, it will not provide adequate protection from breakage because it may slip off accidentally or be slipped off by a child. Opaque sleeves also obscure the contents of the bottle, making it difficult to know if the liquid inside has been consumed or not.

Proper ventilation of baby bottles is another design challenge. As the baby sucks milk out of the bottle, a vacuum is created within. One common design solution is to create a pinhole on the lip of the nipple or somewhere on its surface. However, this opening is not large enough to counteract the significant pressure generated by the baby's suction, especially as the child grows.

Another solution is to vent the bottle via the way it interfaces with the screw on collar. However, if a parent screws on the collar incorrectly or too tightly, ventilation may not occur and leakage may also result. The prior art also includes design solutions that add an additional piece beyond the nipple, bottle and collar. These pieces, while effective, frequently include straws or crevices that are difficult to clean and easy to lose.

### SUMMARY

The above and other needs are met by a mason jar baby bottle lid. In a first aspect, a mason jar baby bottle lid for use on a mason jar is provided, the lid including: a metal threaded mason jar collar, the threaded collar including a substantially flat upper surface around a center opening of the collar and a downward-projecting lip around the center opening; a bottle nipple formed of a flexible and non-toxic material, the bottle nipple comprising: a domed body portion having a nipple projecting from an upper end of the domed body; a flange formed on the lower end of the domed body, the flange having an upwardly protruding lip formed around an outer edge of the flange, the flange having a diameter that is greater than a diameter of an opening of the mason jar; and an annular indentation formed between the flange and the domed body of the bottle nipple and including an overhang surface. A height of the upwardly protruding lip of the flange is such that when the bottle nipple is engaged with the mason jar collar, the overhang surface is adjacent the substantially flat upper surface of the collar.

In one embodiment, a thickness of the domed body portion tapers from a thickest portion above the indentation to a thinnest portion at the projecting nipple.

In another embodiment, the lid further includes a plurality of ribs extending vertically along an inner surface of the bottle nipple from the domed body portion into the projecting nipple.

In yet another embodiment, the lid further includes a support ring formed around an inside of the upper end of the domed body portion and intersecting with the plurality of vertical ribs.

In one embodiment, the flange of the bottle nipple includes a flat bottom surface such that when the mason jar collar and bottle nipple are threadably attached to a mason jar, the flange is substantially sandwiched between a rim of the mason jar and lower surface of the mason jar collar.

In another embodiment, the lid further includes a vent formed on an upper surface of the domed body portion of the bottle nipple.

In yet another embodiment, the vent comprises a duckbill valve formed through the upper surface of the domed body portion.

In one embodiment, a height of the upwardly protruding lip of the flange is at least as high as the indentation.

In a second aspect, a mason jar baby bottle lid for use on a mason jar is provided, the lid having: a metal threaded mason jar collar, the threaded collar including a substantially flat upper surface around a center opening of the collar and a downward-projecting lip around the center opening; a bottle nipple formed of a flexible and non-toxic material, the bottle nipple comprising: a domed body portion having a nipple projecting from an upper end of the domed body; a flange formed on the lower end of the domed body, the flange having an upwardly protruding lip formed around an outer edge of the flange, the flange having a diameter that is greater than a diameter of an opening of the mason jar; and an annular indentation formed between the flange and the domed body of the bottle nipple and including an overhang surface. A height of the upwardly protruding lip of the flange is at least as high as the annular indentation such that when the bottle nipple is engaged with the mason jar collar, the overhang surface is adjacent the substantially flat upper surface of the collar. The flange of the bottle nipple includes a flat bottom surface such that when the mason jar collar and bottle nipple are threadably attached to a mason jar, the flange is substantially sandwiched between a rim of the mason jar and lower surface of the mason jar collar.

In a third aspect, a mason jar baby bottle lid for use on a mason jar is provided, the lid having: a metal threaded mason jar collar, the threaded collar including a substantially flat upper surface around a center opening of the collar and a downward-projecting lip around the center opening; a bottle nipple formed of a flexible and non-toxic material, the bottle nipple including: a domed body portion having a nipple projecting from an upper end of the domed body; a flange formed on the lower end of the domed body, the flange having an upwardly protruding lip formed around an outer edge of the flange, the flange having a diameter that is greater than a diameter of an opening of the mason jar; an annular indentation formed between the flange and the domed body of the bottle nipple and including an overhang surface; wherein a height of the upwardly protruding lip of the flange is at least as high as the annular indentation such that when the bottle nipple is engaged with the mason jar collar, the overhang surface is adjacent the substantially flat upper surface of the collar.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a perspective top view of a mason baby bottle lid according to one embodiment of the present disclosure;

FIG. 2 shows a perspective bottom view of a mason baby bottle lid according to one embodiment of the present disclosure;

FIG. 3 shows a top view of a mason baby bottle lid according to one embodiment of the present disclosure;

FIG. 4 shows a bottom view of a mason baby bottle lid according to one embodiment of the present disclosure;

FIG. 5 shows a cross-sectional side view of a mason baby bottle lid according to one embodiment of the present disclosure;

FIG. 6 shows a side view of a mason baby bottle lid according to one embodiment of the present disclosure;

FIG. 7 shows a cross-sectional side view of a mason baby bottle lid and jar assembly according to one embodiment of the present disclosure;

FIG. 8 shows a perspective view of a mason jar collar according to one embodiment of the present disclosure; and

FIG. 9 shows a perspective view of a mason baby bottle lid and jar assembly according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

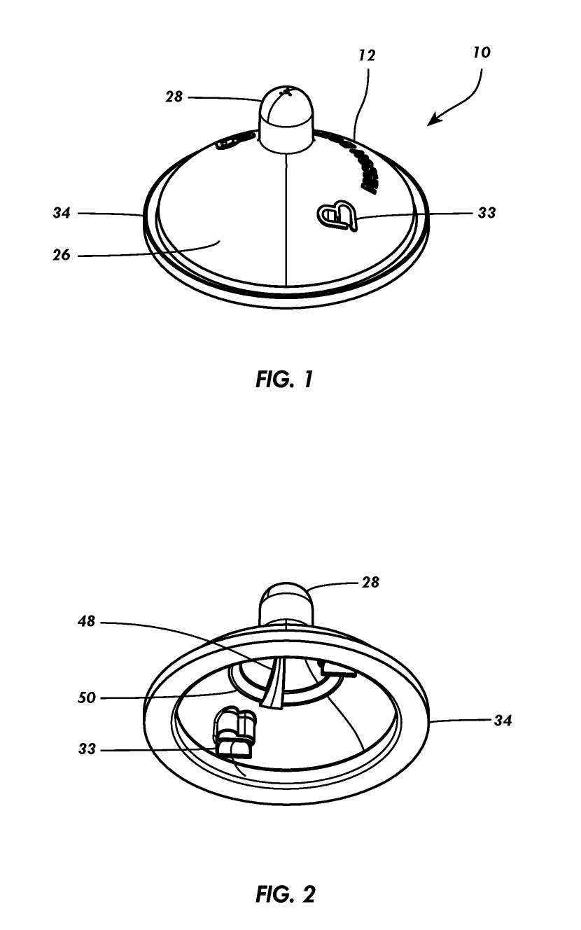

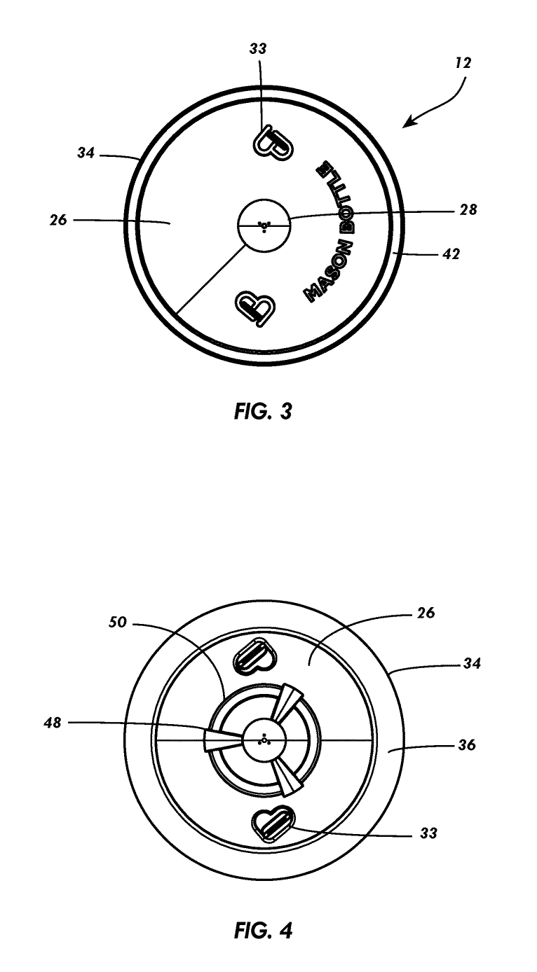

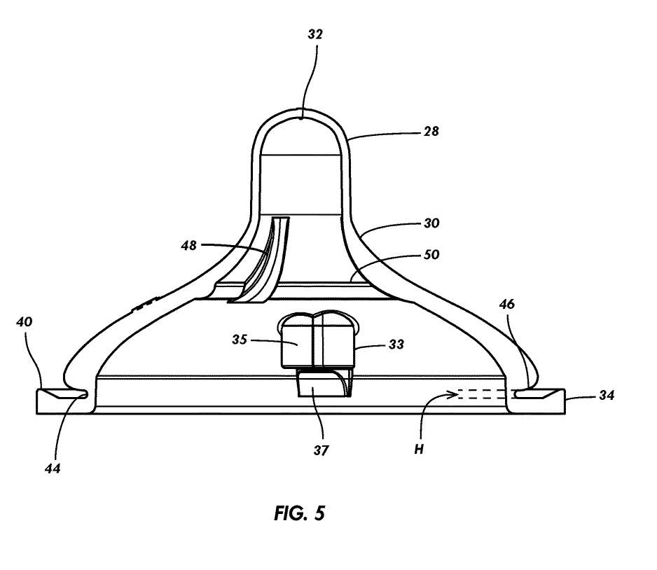

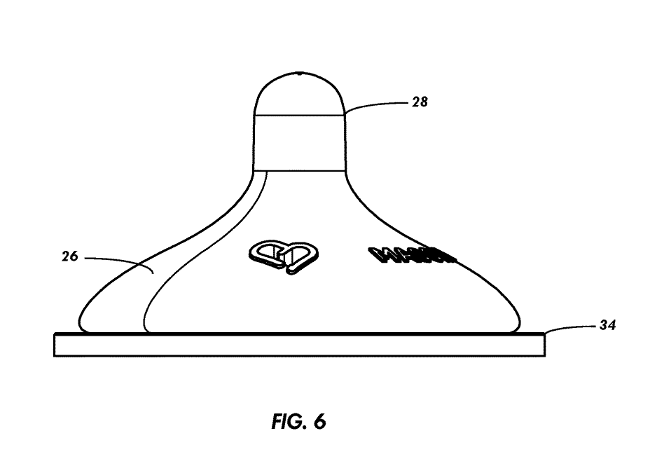

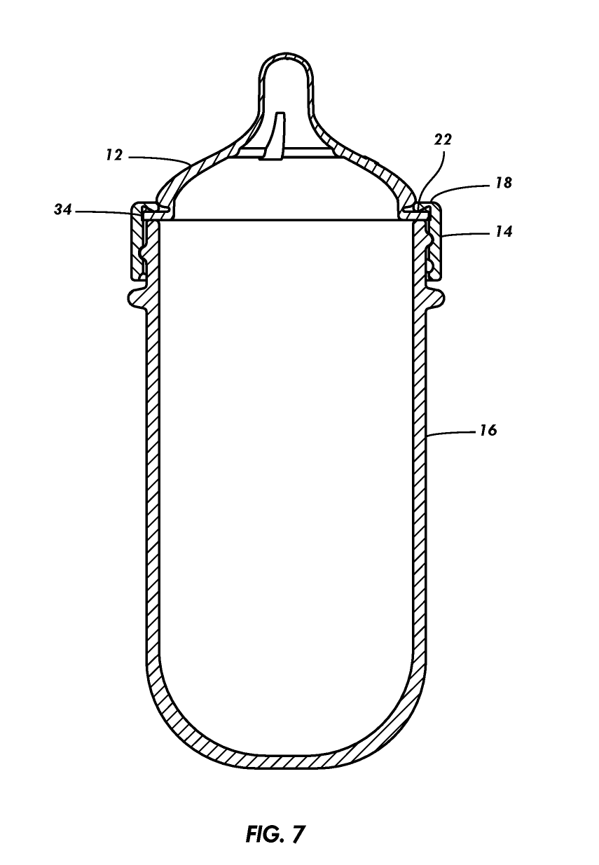

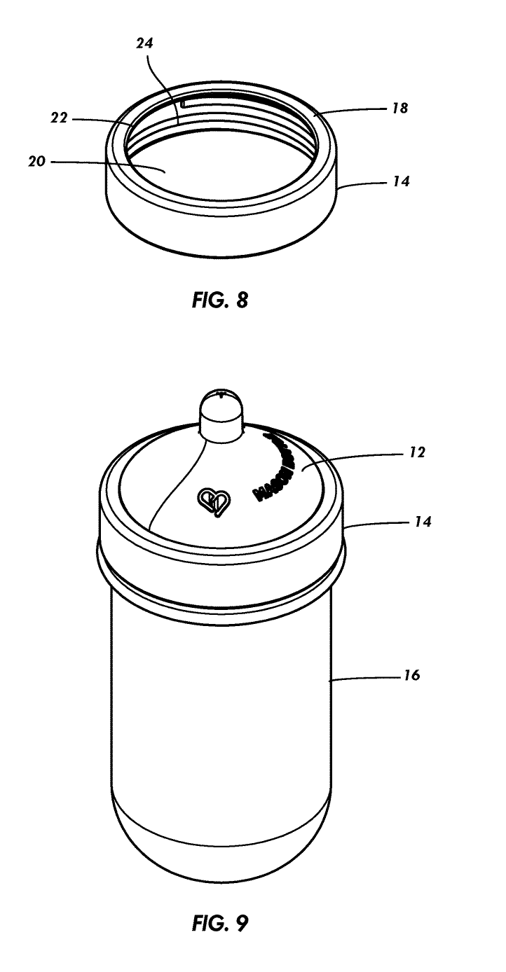

As shown in FIGS. 1 and 2, a mason jar baby bottle lid 10 is provided for mounting to a glass mason jar such that the jar may be used as a baby bottle. The baby bottle lid 10 includes a flexible bottle nipple 12 inserted into a metal threaded mason jar collar 14. The bottle nipple 12 is shaped to tightly fit within the mason jar collar 14. When the bottle nipple 12 is inserted into the mason jar collar 14, and the bottle nipple 12 and mason jar collar 14 are threadably attached to a glass mason jar 16, the baby bottle lid 10 creates a fluid-tight fit such that fluid is only dispensed from the bottle lid 10 at an end of the bottle nipple 12.

The threaded mason jar collar 14 is formed of a mason jar band or collar typically found on a two-piece mason jar lid. The mason jar collar 14 is preferably formed of a corrosion-resistant metal. The mason jar collar 14 includes a flat top surface 18 or a top surface that is substantially flat with a slight stepped portion formed around a center opening 20 of the collar 14. An edge of the center opening 20 is preferably rolled to eliminate a sharp edge of the opening and to create a downward-projecting lip 22 formed around the opening. A threaded portion 24 of the mason jar collar 14 is formed to threadably engage with a threaded portion of a typical mason jar.

The bottle nipple 12 is preferably formed of a flexible, non-toxic material. For example, the bottle nipple 12 is preferably formed of silicone. The bottle nipple 12 includes a hollow domed body portion 26 having a nipple 28 projecting from an upper end 30 of the domed body portion 26. A dispensing aperture 32 is formed on a distal end of the nipple 28 for dispensing a fluid from within the mason jar 16. One or more vents 33 may be formed through a surface of the domed body portion 26.

Referring to FIG. 5, the vent 33 includes a buffer cavity 35 adjacent to the domed body portion of the 26, and a vent portion 37 attached to a bottom of the buffer cavity 35. The vent 37 is positioned below the buffer cavity 35 such that walls of the vent 37, shown as a duckbill valve in FIG. 5, are attached to the bottom of the buffer cavity 35. By attaching the vent 37 to the bottom of the buffer cavity 35, the vent 37 is substantially protected such that if the domed body portion 26 is disturbed or moved, such as during feeding, the vent 37 is not contacted or disturbed thereby reducing a chance of leaking through the valve.

A flange 34 is formed on a lower end of the domed body portion 26 for engaging the bottle nipple 12 with the collar 14. The flange 34 has an outer diameter that is greater than a diameter of the center opening 20 of the collar, and preferably has an outer diameter that is greater than a diameter of an opening of the mason jar 16. The flange 34 includes a flat bottom surface 36 shaped to fit against a rim 38 of the mason jar 16. An upward-projecting lip 40 is formed around an outer edge of an upper surface 42 of the flange for contacting an underside of the mason jar collar 14.

With further reference to FIG. 5, an annular indentation 44 is formed around the bottle nipple 12 between the flange 34 and the domed body portion 26. The indentation 44 forms an overhang surface 46 around the bottle nipple 12. The indentation 44 has a height H between the flange 34 and the overhang surface 46. As shown in FIG. 5, the upward-projecting lip 40 preferably has a height that is equal to or greater than a height of the indentation 44 to create a tight fit with the mason jar collar 14, as discussed in greater detail below.

A thickness of the bottle nipple 12 is preferably tapered from a thickest point towards the lower end of the domed body portion 26 above the indentation 44 to a thinnest point at the nipple 28. A plurality of vertical ribs 48 are formed along an inner surface of the bottle nipple 12 extending from the domed body portion 26 and into the projecting nipple 28. The bottle nipple 12 also preferably includes a support ring 50 formed horizontally around an inside of the bottle nipple 12 and intersecting with the one or more support ribs 48. The tapered thickness, vertical ribs 48, and support ring 50 support the bottle nipple 12 to substantially prevent the nipple 12 from inverting during feeding.

When the bottle nipple 12 is inserted into the collar 14, the indentation 44 contacts an edge of the center opening 20. The lip 40 contacts an underside of the collar 14, and the height of the indentation is such that the overhang 46 at least partial contacts an upper surface of the collar, thereby creating a fluid-tight seal between the bottle nipple 12 and collar 14. When the bottle nipple 12 and collar 14 are threaded onto the mason jar, the flange 34 is sandwiched between a rim of the mason jar and an underside of the collar 14 to prevent movement of the bottle nipple 12.

The present disclosure relates to a shoulder-less glass baby bottle lid that is compatible with the diameter of standard canning jars. Although the invention has other uses, which will be detailed below, its use as a baby bottle is the principle or first use. The baby bottle of the present disclosure includes six pieces: a plastic cap, a silicone nipple, a shoulder-less glass jar, which comes in both 4 and 8 ounce sizes, a metal screw-on collar, and a metal lid with a rubber seal, and a silicone boot or sleeve. In order to use the invention as a baby bottle, the user would fill the glass jar with milk, insert the nipple into the collar, and screw it on. If traveling, the lid could be inserted before putting the nipple in place and screwing on the collar. The plastic cap attaches to the metal collar to protect the nipple. If extra protection is required, the user can add a silicone sleeve to help prevent breakage of the glass jar if dropped.

The present invention is also compatible with standard canning jars. Most canning jars in the United States have a diameter or 2.5 inches. This is significantly wider than most baby bottles. The present invention includes a nipple that fits the 2.5-inch mouth of a standard canning jar. It is made of silicone and it has a lip that interfaces with the rim of the glass canning jar and its screw-on collar. The way the lip and base of the nipple interface with the jar and collar prevents the apparatus from becoming bound up and creating a friction lock. The invention is designed with the proper proportion on the lip of the silicone nipple so that friction lock is prevented and the collar can always be unscrewed without difficulty. The design also prevents leakage.

All baby bottles must include a ventilation feature that counteracts the vacuum that is created as a baby sucks milk out of the bottle. Air must somehow re-enter the bottle in order to equalize the pressure and allow the baby to continually evacuate the bottle without having to release the nipple. The ventilation feature of the present disclosure is preferably a duck bill valve that is recessed into the buffer cavity described above. A logo is outlined on the silicone nipple with a slightly raised surface, and a shape of the buffer cavity may have a cross-sectional area that matches the logo. The buffer cavity down from the outline of the logo, which then transitions into the vent, shown as a duckbill valve in the figures. A slit at the bottom of the valve allows air to enter the bottle without allowing milk to backflow or leak out of the bottle.

The shape of the silicone nipple allows for the nipple to be inverted into the jar. By inverting the nipple, the user is able to store the nipple inside the canning jar itself. The user turns the nipple so that it is upside down, and then positions the nipple on the rim of the jar. The user can then place a canning jar lid on top, and screw on the collar just as they would if the nipple were not there. The nipple shape also closely mimics the shape of the human breast. Because the glass jar that forms the base of the bottle does not have shoulders, the silicone nipple must be significantly wider than most baby bottles. This width means that once the tip of the nipple is inserted into the baby's mouth, the mound of the nipple approaches the nose and chin in the same way that they human breast would, thus facilitating the transition between bottle and breast-feeding.

The invention also includes an optional seventh piece, which is a two-sided handle that is designed to rest on top of the transfer bead of the glass jar, but below the threads of the jar. The handle consists of a central ring that can screw onto the jar and two wings that extend out on either side. The wings make it easier for a baby or child to self-feed. The handle screws onto the threads just as the collar would, until it reaches the end of the threads and drops into the gap between the threads and the transfer bead. The collar can then be put in place over the handle and screwed on to maximum tightness without any interference between the two pieces.

The present invention also has several additional applications utilizing the collar, lid and jar. These three elements are interchangeable with, but not identical to, the collar, lid and jar found on standard canning jars. However, unlike standard canning jars, the glass jar in the invention includes more precise units of measurement in milliliters and ounces. This is particularly useful for parents when the jar is being used as a baby bottle as many parents need to know exact measurements in order to mix formula according to proper ratios or in order to give the correct serving size of milk given the age and weight of their baby. Also unlike canning jar lids and collars which are prone to rusting even after the first wash, these components of the invention are made from rust-proof materials.

The present invention can also be used as a transitional cup for growing children. As the baby grows, the nipple can be switched out to allow for the increasing speed with which the baby evacuates the bottle. When it comes time to transition the baby to drinking from cups, a new silicone piece can be inserted in place of the nipple to facilitate this transition and limit spillage. Once the child no longer needs assistance, the lid and collar can be removed and the jar itself can be used as a cup.

The present invention can also be used for breast milk storage. By removing the nipple and filling the jars with milk, the user can store breast milk or formula in the refrigerator or freezer.

Because the jars do not have a shoulder, they can be stacked to save space on storage. When removed from cold storage, the bottle can be assembled and heated all from the same jar, eliminating the need to transfer the milk from a stackable storage vessel to a baby bottle, and eliminating the need to wash extra containers.

The present invention can also serve as a container for food storage. The invention is particularly useful for baby food storage, but could be used to store any kind of food or any other item. The present invention includes a plastic cap that snaps onto the collar of any standard canning jar. The cap has three latches. Each latch has a small tab that protrudes from the base. The tab highlights the location of each latch and makes it easier to unlatch when applying upward pressure with a finger or thumb.

The present invention also includes two silicone protective sleeves or boots for the most common canning jar sizes. Our invention includes a unique silicone sleeve for each jar size. The silicone sleeve has two cut-outs about 1 inch wide. Fingers can be inserted into these cut outs to assist with application of the sleeve to the jar. The cut outs also make it possible to see the contents of the jar and the level of liquid remaining. The diameter of the sleeve and boot, which is slightly smaller than the diameter of the glass jar, keeps the sleeve in place on the glass jar. It stretches just enough to make it easy for an adult to put on, but it is also tight enough that a child's finger strength and fine motor skills are not great enough to remove it.

The benefits of the present invention, in its preferred embodiment, include:
The present invention addresses shortcomings in the prior art, specifically, by making a shoulder-less glass baby bottle, the user is given the ability to stack stored milk and is no longer required to use special tools for cleaning in, around, and underneath the neck of the bottle.
Within its use as a baby bottle, the nipple itself has several features that provide additional benefit. First, the diameter of the nipple is compatible with standard canning jars so that it may be used in conjunction with jars that the user already owns or can acquire more cheaply than a set of baby bottles.
The nipple also has a unique ventilation feature that is wider and easier to clean than standard bottles. The ventilation feature includes a buffer cavity formed in the domed portion of the nipple which then transitions into the valve.
The valve itself is a duckbill valve that allows air to flow back into the bottle and balance out the negative pressure created by the baby's suction on the bottle. Because the ventilation feature is a valve rather than a pinhole, it is able to counteract ever increasing negative pressure as the child grows and begins to suck harder on the bottle. The valve design is also robust enough to be used when the child is ready to use a transitional cup. Because the entire ventilation feature is part of the silicone nipple itself, there are no extra pieces to clean. The ventilation feature is self-cleaning because it allows for the buffer cavity to be filled with water, and the pressure of the water sitting above the valve forces it through the slit to rinse it thoroughly.
Within the invention's use as a breast milk or formula storage vessel, it provides the extra benefit of enabling caretakers to store, heat and serve milk all from the same container.
In addition to use for bottle feeding and milk storage, the invention can also be used as a transitional cup for children or as a food storage container. The invention has the additional benefit of being compatible with standard canning jars, thus allowing the customer to reuse the invention in a variety of ways after baby outgrows the bottle.

The mason jar baby bottle nipple and lid of the present disclosure advantageously allows a user to convert a standard mason jar and threaded metal collar of the mason jar into a baby bottle for feeding. Existing baby bottles and nipples rely on custom shaped collars to prevent leaking between a baby bottle and the lid and nipple. Further, while it may be possible to insert existing baby bottle nipples into a mason jar collar, it is often difficult to insert the nipple into the collar, and such fit is not leak proof. The baby bottle nipple of the present disclosure is advantageously shaped to snuggly fit within a thinner mason jar collar such that the nipple forms a tight seal to the collar to prevent leaking while remaining easy to install or remove from the mason jar collar.

Shaped collars used with existing bottle nipples also aid in preventing collapse of the nipple during feeding. Without a custom shaped collar, the wide opening of the mason jar collar would result in an ordinary bottle nipple not having an appropriate shape or support, and the nipple would therefore collapse into the mason jar when suction is applied during feeding. The overhang, indentation, thickness, and other features of the baby bottle nipple of the present disclosure advantageously allow the nipple to be used with an existing mason jar collar while preventing collapse or inversion of the nipple during feeding.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A mason jar baby bottle nipple for use on a mason jar having a metal threaded mason jar collar that has a flat upper surface around a center opening of the collar and a downward projecting lip around the center opening, the mason jar baby bottle nipple comprising:
a bottle nipple formed of a flexible and non-toxic material, the bottle nipple comprising:
a domed body portion having a nipple projecting from an upper end of the domed body;
a flange formed on the lower end of the domed body, the flange having an upwardly protruding lip formed around an outer edge of the flange, the flange having a diameter that is greater than a diameter of an opening of the mason jar;
an annular indentation formed between the flange and the domed body of the bottle nipple and including an overhang surface;
wherein a height of the upwardly protruding lip of the flange is such that when the bottle nipple is engaged with the mason jar collar, the overhang surface is adjacent the substantially flat upper surface of the collar.

2. The mason jar baby bottle nipple of claim 1, wherein a thickness of the domed body portion tapers from a thickest portion above the indentation to a thinnest portion at the projecting nipple.

3. The mason jar baby bottle nipple of claim 1, further comprising a plurality of ribs extending vertically along an inner surface of the bottle nipple from the domed body portion into the projecting nipple.

4. The mason jar baby bottle nipple of claim 3, further comprising a support ring formed around an inside of the upper end of the domed body portion and intersecting with the plurality of vertical ribs.

5. The mason jar baby bottle nipple of claim 1, wherein the flange of the bottle nipple includes a flat bottom surface such that when the mason jar collar and bottle nipple are threadably attached to a mason jar, the flange is substantially sandwiched between a rim of the mason jar and lower surface of the mason jar collar.

6. The mason jar baby bottle nipple of claim 1, further comprising a vent formed on an upper surface of the domed body portion of the bottle nipple.

7. The mason jar baby bottle nipple of claim 6, wherein the vent comprises a duckbill valve formed through the upper surface of the domed body portion.

8. The mason jar baby bottle nipple of claim 6, wherein the vent comprises a buffer cavity adjacent to the domed body portion of the bottle nipple and a valve portion formed on a bottom of the buffer cavity.

9. The mason jar baby bottle nipple of claim 1, wherein a height of the upwardly protruding lip of the flange is at least as high as the indentation.

10. A mason jar baby bottle nipple for use on a mason jar having a metal threaded mason jar collar that has a flat upper surface around a center opening of the collar and a downward projecting lip around the center opening, the mason jar baby bottle nipple comprising:
a bottle nipple formed of a flexible and non-toxic material, the bottle nipple comprising:
a domed body portion having a nipple projecting from an upper end of the domed body;
a flange formed on the lower end of the domed body, the flange having an upwardly protruding lip formed around an outer edge of the flange, the flange having a diameter that is greater than a diameter of an opening of the mason jar;
an annular indentation formed between the flange and the domed body of the bottle nipple and including an overhang surface;
wherein a height of the upwardly protruding lip of the flange is at least as high as the annular indentation such that when the bottle nipple is engaged with the mason jar collar, the overhang surface is adjacent the substantially flat upper surface of the collar; and
wherein the flange of the bottle nipple includes a flat bottom surface such that when the mason jar collar and bottle nipple are threadably attached to a mason jar, the flange is substantially sandwiched between a rim of the mason jar and lower surface of the mason jar collar.

11. A mason jar baby bottle nipple for use on a mason jar having a metal threaded mason jar collar that has a flat upper surface around a center opening of the collar and a downward projecting lip around the center opening, the mason jar baby bottle nipple comprising:
a bottle nipple formed of a flexible and non-toxic material, the bottle nipple comprising:
a domed body portion having a nipple projecting from an upper end of the domed body;
a flange formed on the lower end of the domed body, the flange having an upwardly protruding lip formed around an outer edge of the flange, the flange having a diameter that is greater than a diameter of an opening of the mason jar;
an annular indentation formed between the flange and the domed body of the bottle nipple and including an overhang surface;
wherein a height of the upwardly protruding lip of the flange is at least as high as the annular indentation such that when the bottle nipple is engaged with the mason jar collar, the overhang surface is adjacent the substantially flat upper surface of the collar.
